(19) United States
(12) Patent Application Publication
(10) Pub. No.: US 2009/0053388 A1
(43) Pub. Date: Feb. 26, 2009

(54) Flavor emitting compositions, devices and packaged food products therewith

(76) Inventors: Thomas Powers, Mayville, NY (US); John Crump, Buffalo, NY (US); George McKedy, Williamsville, NY (US)

Correspondence Address: SIMPSON & SIMPSON, PLLC, 5555 MAIN STREET, WILLIAMSVILLE, NY, 14221-5406, US

(21) Appl. No.: 11/895,545

(22) Filed: Aug. 24, 2007

(51) Int. Cl. A23L 1/221

(52) U.S. Cl. 426/650; 426/654

(57) ABSTRACT

Instead of direct introduction into recipes of food products, for example, flavorant emitting compositions including at least one flavorant are in combination with a stabilizer, e.g., adsorbent or absorbent, and indirectly added to the food product via a closed environment of a package by readily releasing the flavorant from the substrate. When a device, such as a porous sachet comprising the compositions is placed in a closed environment of a food package, for example, a constant fresh aroma and/or taste is delivered to the closed atmosphere of the packaged foodstuff and deposited onto the foodstuff per se for preserving and maintaining product freshness for enhanced consumer acceptance. Representative packaged products would include snack foods, such as barbecue chips, potato chips, bakery products, to name but a few.

### FIELD OF THE INVENTION

The invention relates generally to improved compositions for imparting flavorants to products, to packaging of the flavorants, methods of manufacturing the compositions and methods of use thereof.

### BACKGROUND OF THE INVENTION

Certain packaged items, particularly food products may require enhanced or altered flavor properties for better consumer acceptance. This can be accomplished by the addition of a flavorant to the food product, e.g. taste, flavor aromatics, and mouthfeel. Additionally, consumers often desire a more robust aroma or flavor in certain packaged food products than what is currently available. Current methods of delivering flavorants have not proven totally effective in delivering more robust or enhanced flavors. Additionally, there are certain packaged items, such as snack foods, and especially bakery items, which pose difficulties with respect to traditional flavoring methods.

For baking, the traditional method of adding flavorants requires the manufacturer to simply directly blend the desired flavorants into the mixture prior to baking. However, flavorant carriers tend to release a substantial portion of the flavorant well before baking is complete. Additionally, and more frequently, the actual flavorant molecules are often unable to withstand the intense heat of the baking process for the duration of the baking time. Flavorants can breakdown, rendering them ineffective, especially in the case of fruit flavors, such as citrus and berry. To remedy this problem, it has been the practice of manufacturers to apply two and three times the amount of flavorant than would ideally be employed in the recipes. While this method can be effective in manufacturing product with the desired flavor impact, it is not an efficient use of flavorants, and often leads to greater waste.

Food processors and manufacturers in some instances use spray-on flavorants after the baking/cooking steps. This can be an effective use of flavorants in introducing the desired flavors to the food product, since the flavorants are not exposed to the baking process which can lead to a breakdown of the flavorant. However, the effectiveness of the added flavorants can be temporary. Over time, flavorants age and lose potency, through decomposition or evaporation. Furthermore, since flavorants are often directly applied, e.g., sprayed on, there is a tendency for the flavorants to be brushed off or dissipate during packaging, handling and transport. Overall, one key shortcoming with the direct application method is the quantity of flavorant added to the food product, and when the flavorant dissipates there is no further flavorant available to offset this loss.

Some manufacturers only add flavor aromatics to packaged items while ignoring taste flavorants. This is disclosed in U.S. Pat. Nos. 6,045,833; 7,005,152; and U.S. Patent Application Publication 2004/0028779, inclusively. This method comprises capturing olfactory odorants within polymers through absorption, which are then used in manufacturing packaging or packaging components. The polymers release aroma over time through blooming, so that the consumer experiences a fresh aroma when the packaged item is first opened and consumed. Aroma is imperative to the processing of taste, but tasting still requires specific chemical interaction with receptors on the tongue, which does not reliably occur. Furthermore, the methods disclosed by U.S. Pat. Nos. 6,045,833; 7,005,152; and, U.S. Patent Application Publication No. 2004/0028779, rely on producing a supersaturated plastic composition at ambient temperatures, which can result in flavorants precipitating out of the plastic over time, e.g. bloom. Additionally, some manufacturers blend plastic melts with flavorants prior to molding, however due to the high temperatures of such melts, flavorant decomposition and volatization often occurs.

Certain manufactured and packaged products, such as bakery goods, potato chips and other snack type foods have limited shelf life of several days to weeks. From production to the time of sale and consumption, packaged food products have a tendency to lose flavor and aroma with the passage of time. Such losses detract from customer acceptance.

Accordingly, there is a need for formulations and methods of delivering flavors to packaged items, including food and non-food items in an economical and efficient method substantially free of degradation over time, so any natural dissipation of taste, aroma, or feeling factors, e.g., astringency, of packaged products and their replacement are in equilibrium.

### SUMMARY OF THE INVENTION

It is therefore one principal object of the invention to provide novel stabilized flavor emitting compositions comprising at least one flavorant in a stabilized format e.g., gelled, solidified or deposited onto a solid carrier. The stabilizer may be a sorbent, a resin, hydrocolloid or other suitable macromolecule capable of solidifying or encapsulating the flavorant. The compositions include a stabilizer in combination with at least one flavorant or mixtures thereof, which perform as stimuli of human flavor senses, and more specifically, of olfaction, taste and sensation, both oral and nasal, and combinations thereof. Other noteworthy properties of flavor emitting compositions of the invention include their handling properties, wherein granular stabilized forms can be free flowing and characterized by ease of movement, resin or hydrocolloid stabilized compositions pastes or semisolids capable of coating, molding or being deposited efficiently, and possess other properties discussed hereinbelow, e.g., adhesion.

A further principal object of the invention includes delivery devices for the flavor emitting compositions, wherein the devices comprise at least one stabilized flavorant composition deposited onto a substrate, and packaged into a delivery device adapted to optimize release of the flavorant into the environment surrounding the foodstuff, for example. The invention contemplates various embodiments of delivery devices with at least partially porous surface(s), e.g., porous top sheets, and which are adaptable for various applications and end uses. Examples of such devices include, but are not limited to, self-adhesive devices, sheets, coatings, canisters, trays, molded trays, tablets, sachet, and molded tablets or forms. It is yet a further object of the invention to provide a packaged food product which includes at least one present invention flavorant device.

It is still a further object to provide methods of making and packaging the flavor emitting compositions for optimizing their delivery for particular end-use applications, as disclosed herein. For example, the present invention comprises a method of manufacturing a flavorant emitting device including the steps of: (i) integrating a stabilizer with at least one flavorant to create a flavorant emitting composition; and, (ii) packaging the flavorant emitting composition in an at least partially porous containment device. In some embodiments, the step of packaging the flavorant emitting composition in an at least partially porous containment device further includes: depositing the flavorant emitting composition onto a base sheet to form a base layer; covering the base layer with a top sheet; and, sealing the top sheet to the base layer. Additionally, the present invention further comprises a method of manufacturing a flavorant emitting composition including the steps of: selecting at least one flavorant absorbable in a packaged food product; selecting a stabilizer that will combine with the flavorant to form a solid or semi-solid form; and, combining the selected at least one flavorant with the selected stabilizer to obtain the flavorant emitting composition.

These and other objects, features and advantages of the present invention will become more readily apparent to those of ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing Figures, wherein

FIG. 1 is a schematic of a process for manufacturing a flavor emitting composition;

FIG. 2 is a top view of a sheet of self-adhesive packets as containments for releasing flavor emitting compositions;

FIG. 3 is a top view of the self-adhesive packets for containment for flavor emitting compositions;

FIG. 4 is a side elevational view of the containment self-adhesive packets shown in FIG. 3;

FIG. 5 is a sectional view of the containment self-adhesive packets taken along line 5-5 of FIG. 3;

FIG. 6 is top view of a sheet of multiple self-adhesive packets containing flavor emitting compositions of the invention with perforations for ease of separation;

FIG. 7 is a top view of strip of containment release self-adhesive packets for flavor emitting compositions of the invention;

FIG. 8 is a side elevational view of a roll of the self-adhesive packets shown in FIG. 7;

FIG. 9 is a perspective view of a canister type containment vessel for delivery of flavor emitting compositions;

FIG. 10 is a top view of the canister shown in FIG. 9;

FIG. 11 is an end view of the canister shown in FIG. 9;

FIG. 12 is a rear view of the canister shown in FIG. 9;

FIG. 13 is a side sectional view of the canister type containment vessel taken along line 13-13 of FIG. 10;

FIG. 14 is a perspective view of a sachet type containment/release packaging for the flavor emitting compositions of the invention;

FIG. 15 is a top view of the sachet shown in FIG. 14;

FIG. 16 is a bottom view of the sachet shown in FIG. 14;

FIG. 17 is a side view of the sachet shown in FIG. 14;

FIG. 18 is a sectional view of the sachet taken along line 18-18 of FIG. 15;

FIG. 19 is a top view of a tare-off strip of sachets connected end-to-end;

FIG. 20 is an exterior view of a bag of edibles containing a self-adhesive packet filled flavor emitting composition of the invention;

FIG. 21 is a partial cut-away view of the bag of edibles shown in FIG. 20;

FIG. 22 is a side sectional view of a tray for foodstuff illustrating with self-adhesive flavorant packets and sachet positioned in the interior thereof;

FIG. 23 is a perspective view of a tablet type containment/release packaging for the flavor emitting compositions of the invention; and,

FIG. 24 is a side sectional view of the tablet type containment/release packaging taken along line 24-24 of FIG. 23.

### DETAILED DESCRIPTION OF THE INVENTION

For purposes of this invention the following terms and expressions as appearing in the specification and claims are intended to have the following meanings:

### Flavorant

The term “flavorant” is intended to mean both natural and artificial varieties. This is intended to include “natural flavorants” as defined by Title 21 of the U.S. Code of Federal Regulations, namely essential oils, oleoresins, essence or extractive, protein hydrolysates, distillates, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional. 21 CFR 101.22.

Flavorant(s) is also intended to include “artificial flavorants”, in particular, chemically synthesized compounds of natural flavorants that do not necessarily meet the specifications stated above. Artificial flavorants may include chemical compounds found in “natural flavorants.”

In addition to the foregoing definitions of “flavorant”, for the purposes of this invention, the term “flavorant” is also intended to be a general term to denote an agent that imparts three aspects: taste, flavor aromatics, and feeling factors. Tastes are sensations that are processed through receptors on the tongue, and generally include salt, sweet, sour, and bitter. Flavor aromatics are those flavor volatiles emitted while biting, chewing, drinking and swallowing food, and are sensed by the olfactory receptors. Feeling factors, in the language of flavor, describe sensations perceived in the mouth, on the tongue, or in the nasal passages (or anywhere in the oral/nasal cavities). These sensations are separate and distinct from tastes, salt, sweet, sour and bitter, and from the myriad of flavor aromatics perceived by the olfactory sense. Compounds which produce these sensations vary in volatility but many are susceptible to vapor phase transfer. Such feeling factors include the pungency of “smoke” flavors, astringency of fruits, cooling of mints, or the heat of peppers. More specifically, a flavorant may enhance or change the taste or the aroma of an item, or both the taste and aroma. This change may be to either enhance a desired taste or flavor, or mask an undesirable taste or aroma. It should be appreciated that flavorants, in most applications, are non-toxic and ingestible.

While some flavorants may also possess associated odorant properties or have utilities as perfuming agents, e.g., certain essential oils, fruity, herbal or floral, nutty or sweet properties, musk, to name but a few, and can be used for masking, hiding or disguising odors of packaged products, for purposes of the present invention, the terms “flavorant” and “flavor” as appearing in the specification and claims are not intended to include compounds or compositions generally recognized as fragrances, perfuming agents, perfume raw materials or PRMs or substances useful in imparting smell/aroma to products exclusively, or in masking odors, such as disclosed in US patent application Publication US 2005/0096220.

Correspondingly, it should also be understood that while flavorants may include flavor aromatics, some components of flavorants do not possess olfactory stimulating properties. For example, flavoring condiments, some spices and seasonings, including artificial sweetners, while lacking olfactory stimulating properties, are nevertheless useful flavorants in practicing the present invention. Certain spices or mixtures of spices for flavoring packaged snack foods, including such representative examples as potato chips, corn chips, barbecue chips, cheese crackers, as well as others, may be seasoned with homogeneous and heterogeneous combinations of solid or particulate spices and condiments, such as a spicy barbecue flavorant. They possess flavorant (taste) enhancing properties, and therefore, are useful flavorants along with other spices commonly applied to foodstuff as flavoring agents in manufacturing processes.

It should be appreciated that the following is not a comprehensive list, but is only representative of some common taste flavorants, plus some sensation producing flavorants. Examples of taste and sensation producing flavorants include, artificial sweeteners, glutamic acid salts, glycine salts, guanylic acid salts, inosinic acid salts, ribonucleotide salts, and organic acids, including acetic acid, citric acid, malic acid, tartaric acid, polyphenolics, and so on.

It should also be appreciated that the following is not a comprehensive list, but is only exemplary of common flavor aromatics. There are thousands of molecular compounds that may be combined or used independently to create a particular desired flavor. A few representative examples of common flavor aromatics include isoamyl acetate (banana), cinnamic aldehyde (cinnamon), ethyl propionate (fruity), limonene (orange), ethyl-(E,Z)-2,4-decadienoate (pear), allyl hexanoate (pineapple), ethyl maltol (sugar, cotton candy), methyl salicylate (wintergreen), and mixtures thereof.

### Emitting

For purposes of this invention, the term “emitting” as appearing in the specification and claims is intended to mean volatilization. Emitting is the release of molecules from a substrate. Emitting is proportional to the vapor pressure of molecules of flavorant, and the like. Preferred flavorants for use according to the invention should be volatile enough to effect vapor phase flavor transfer. The rate at which the flavorant emits is governed by the diffusivity of the volatiles from the stabilized form. Thus, if the stabilizer is an adsorbent that is placed in a containment device, diffusivity is regulated by the porosity of a surface of the containment device. Greater diffusion can be achieved by increasing porosity, thus increasing the rate of flavor emission. The same principle holds if the stabilizer is a resin, hydrocolloid, or other complex carbohydrate or protein capable of entraining the flavor.

Additional factors affecting the emission rate of the flavorant include the overall concentration of the flavorant in the stabilized form, and the vapor pressure of the flavorant as modified by the stabilizer. In the case of the concentration, if there is a higher concentration gradient between the ambient environment and the stabilized form, it is more likely that the flavorant will volatize from the stabilizer and diffuses into the environment. The vapor pressure of the flavorant is an inherent property of the flavorant used, but it is modified by the stabilizer. Since the stabilizer has a degree of affinity for the flavorant, this decreases the degree of volatilization of the flavorant into the environment versus its non-stabilized form.

### Stabilization

Stabilization means that a liquid flavorant is immobilized, solidified, encapsulated, or otherwise converted into a solid or semi-solid form, without the use of heat or other processes that would change or degrade the flavorant, or diminish the flavorant's intensity. A major thrust of the invention resides in the “stabilization” of the flavorant in a manner that the original flavorant is delivered chemically unmodified in a sufficient amount to the enclosed environment, e.g., headspace of a closed package, and also be absorbed by the enclosed product, e.g., foodstuff, such as tortilla chips, potato chips and crisps, cakes, cookies, baked foods, fried foods, and so on. Thus, “stabilization” according to the present invention should allow flavorant to readily volatilize and transfer to the enclosed environment and product contained therein. Preferred methods of stabilization according to the present invention include agents suitable to encapsulate/stabilize the flavorant in such a manner, so it is immobilized prior to use, but also be capable of allowing the flavorant to volatilize, without substantially altering its composition, from the matrix of the stabilizer when introduced into a food package; for example, for enhancing the natural aroma (smell) and taste (flavor) of the packaged foodstuff, especially when the packaged foodstuff is initially opened by the consumer. It should be appreciated that one of the benefits of a present invention “stabilized” flavorant is that the flavorant may be handled as a solid paste, block, granules or coating. It should be appreciated that the flavorant is released and absorbed over a time period of three hundred sixty-five (365) days or more, preferably, the flavorant is released and absorbed over a time period of about one (1) day to about thirty (30) days.

Preferred representative stabilizers according to the invention include the hydrocolloids, such as gels and gums, e.g., carrageenan; locust bean gum, guar gum; resins, such as polyvinyl pyrrolidone (PVP), polyvinyl alcohol (PVOH), acrylic resins, e.g., polymers of acrylic and methacrylic esters, such as methyl, ethyl and butyl acrylates and methacrylates; cellulose ethers based on etherification products of cellulose, such as ethyl cellulose, methyl cellulose, sodium carboxymethyl cellulose, alginates or alginate gums, and so on; and sorbents such as silica gel, silica hydrogels, clays, carbons, diatomaceous earth, pearlite, zeolytes, etc. Other suitable stabilizers include any gel-paste-like polymeric substances that can encapsulate/stabilize the flavorant/odorant in such a manner, so that it is immobilized during storage, but will readily volatilize from the stabilizer-carrier-sorbent matrix during use when packaged in a food product, for instance. Gels and pastes are preferred, whereas hardened matrices comprising thermoplastic or thermosetting resins are less preferred.

A judicious choice of stabilizer is one which can be portioned and dispensed into its final container or upon a carrying surface. A granular stabilizer should be free flowing. Resin based stabilizers should be readily deposited or coated onto the desired carrying surface. However, a gum-based stabilized flavorant should be able to be portioned or formed, extruded, sheeted, rolled, or carved into its final shape and deposited into its container or onto carrying material surface.

When choosing a granular stabilizer, since the flavorants are often in liquid form, the granular adsorbents will have a tendency to adhere to each other. However, after a sufficient amount of equilibration time (typically greater than 24 hours), the adsorbed composition should no longer be tacky, but should be free flowing. Then it can be readily handled and inserted into its sachet or other carrying container through conventional means.

The flavorant, thus stabilized and contained, is able to volatize and impart flavor to the enclosed environment, where it can be absorbed by the food product therein, in sufficient concentration to enhance the natural flavor of the food product. This differs from the current state of the art, wherein the flavorants are either added during the manufacture of the food product, or added directly to the product after manufacture.

The flavorant compositions of the invention may also possess oxygen absorbing, moisture/humidity regulating properties to guard against oxidative degradation of the flavorant or the food product per se, as well as keeping the food product, for instance, moist or soft. Similarly, the flavorant composition could have a volatile antimicrobial component to enhance food safety and retard spoilage. Additionally, each of the above components could easily function separately, that is, the antimicrobial component could be stabilized in a similar fashion as the flavorant, but without the flavorant being present.

The stabilized flavorant composition may also be coated onto or deposited into a containment device, which is sufficiently porous to facilitate volatilization or emission of the flavorant therefrom without fractionating the flavorant into component parts. In the package, the aromatic flavorant readily volatilizes from the porous, stabilized flavorant containment, so that it enters the space surrounding the food and from there absorbed during the time of storage of the packaged foodstuff. That is, the packaged stabilized flavorants retained within the food packaging, such as applied to the interior of a container/bag, are at the same time capable of releasing flavor without fractionating the flavorant into its multiple components when released into the headspace of the package, for example.

The flavorant compositions of the invention should contain a sufficient concentration of the flavorant on the carrier/sorbent, so the targeted substrate, e.g., foodstuff and space surrounding the foodstuff will imbibe the desired flavor during volatilization/emission in the enclosed food package.

The choice of stabilizer, according to the present invention, should be guided by the requirement that it allows the flavor composition to readily volatilizes without being fractionated, and in a sufficient amount to be absorbed by the packaged foodstuff during the storage time period. That is, the stabilizer should not inhibit vapor phase transfer of flavorant, to the interior of the flavorant packaging, and eventually to the outer environment to be absorbed by the packaged foodstuff without the flavorant undergoing fractionation. Typically, fractionation occurs when a flavorant composed of a plurality of differing molecular components, and wherein one or more of the components remains affixed to the sorbent carrier or undergoes decomposition. Such occurrences have the effect of changing the character of the flavor, therefore when the fractionated flavor is absorbed by the foodstuff, it will produce an off-flavor that is undesirable. The methods of the present invention are characterized over previous methods in that volatilization/emission of the flavorant occurs without the flavorant undergoing chemical fractionation. Thus, the products and methods of the present invention have the added benefit of avoiding change in the composition of the flavorant in the release/volatilization/emission process, so the original flavorant composition remains intact, i.e., no relevant components of the original flavorant composition are removed, destroyed or chemically modified.

Accordingly, a major thrust of the invention resides in the stabilization of the flavorant in a manner that the original flavorant is delivered chemically and physically unmodified in a sufficient concentration in the enclosed package environment, e.g., headspace of the closed food package, to be absorbed by the enclosed product, e.g., foodstuff, such as tortilla chips, potato chips and crisps, cakes, cookies, or other baked foods, fried foods, and so on. Thus, “stabilization” according to the present invention should solidify the flavorant but allow the flavorant to readily volatilize from the stabilized composition and transfer to the enclosed environment and product contained therein. In other words, “stabilization” is intended to mean the solidification, entrapment, viscosity modification, adsorption or absorption of a flavorant rendering it into a solid or semi-solid state that can be handled or easily transferred in a form other than a liquid.

Preferred methods of stabilization according to the present invention include agents suitable to encapsulate/stabilize the flavorant in such a manner, so they are immobilized prior to use, but also are capable of volatilizing the flavorant from the matrix of the stabilizer when introduced into a food package, for example, for enhancing the natural taste, flavor, and mouth feel of the packaged foodstuff.

Preferably, particulate or resinous stabilizers are microporous (having porous surfaces on a micro scale), such as: sintered or expanded polymers available from MicroPore Plastics, Inc.; expanded polystyrene beads known as BASF Styropor BFL 327; also cellulose fibers; porous silica gels; molecular sieve, activated carbon, clay, and diatomaceous earth. Most preferred are the silica gels, especially silica gels having particle sizes ranging from about 0.01 millimeters (mm) to about 2.0 mm, with an average pore size range from about 285 Angstroms (Å) to about 315 Å, which are readily available through ordinary channels of commerce from several manufactures. Silica gels hold and release significant amounts of flavorant. In addition, since silica gels have a great affinity for moisture, as moisture is adsorbed, the flavor is desorbed into the surrounding environment. Silica gels of the foregoing pore size are also known as Type B Wide Pore 300 Å Silica Gel, and they, along with molecular sieve are preferred because they hold the desired content of flavorant accommodating the relatively large sizes of flavorant molecules in about a 1:1 ratio while readily releasing flavorant as moisture is adsorbed. It was found that smaller pore sizes do not adsorb as much flavorant, but may be effectively employed. Selection of the adsorbent/stabilizer is also dictated by the flavorant composition employed.

As previously pointed out, flavorants comprise various compounds in thousands of varieties, thus making it somewhat uncertain to determine in advance the precise level of sorption necessary in all instances. Flavorant varieties in combination with the variable nature of the capacity of an individual's sense of taste and smell, makes it somewhat difficult to determine with absolute certainty adequate adsorption or emission levels. In preparing the compositions of the invention, a food flavor enhancing amount of the flavorant, and/or combinations of flavorants are normally introduced into the stabilizer of the invention wherein they are incorporated therein for emitting. The optimal loading of flavorant/odorant onto an adsorbent can also be determined through trial and error and confirmed through sensory analysis of the product involved.

The flavorant compositions of the invention may be deposited by any of the usual methods, such as screen printing, slot head coating, continuous stream, hot melt methods, and the like. The flavorant may be deposited directly onto or in the carrying surface and packaged according to the methods of the invention, including steps of sealing, coating, laminating, curing and cutting to size.

Porosity of the containment devices for the flavorant emitting compositions can control diffusion of the emitting compositions, and thereby control the volatilization rates. Higher flavorant loading rates lead to fewer materials and higher yields in manufacturing. Preferably, the flavorant is added to the stabilizer at the highest possible concentration. Thus, the preferred loading level can be determined for specific combinations of flavorants and adsorbents, that can be repeated for a continuous manufacturing process.

It should be appreciated that although the food industry may be a primary industry for flavorant emitting compositions and devices of the invention, the flavorant emitting compositions of the invention can be used in other applications such as medications, cosmetics, lip coatings, tooth cleansers, and the like.

Flavorants per se are preferably of the type that are in a liquid form or are in a liquid medium allowing for simplified mixing with other flavorants, and also act as a preferable mode of mixing flavorant with adsorbent. Any liquid medium known in the art can be used, but oil-based mediums, alcohol or polyol mediums, or aqueous-based mediums for flavorants are preferred.

As previously mentioned, flavorants can be adsorbed onto the sorbent/carrier in about any ratio, however, the preferred ratio is at least about 1:1 by-weight. Higher loadings are achievable, but there is an upper limit of flavorant that can be adsorbed, which is limited by the overall capacity of the stabilizer.

Where a granular or particulate stabilizer is used, it is desirable to have it free flowing. Free-flowing is desirable because it allows for easy incorporation into current production and manufacturing lines where the composition can be deposited via auger feeders, gravity feeders, or similar mechanical production devices. When a composition loses its free flowing characteristics it is an indication that no additional flavorant can be adsorbed. Such indicator can be discovered with specific flavorants and adsorbents through trial and error experimentation.

When the preferred stabilizer 300 Å silica gel is used, the maximum amount of flavorant that can be adsorbed varies with the type of flavorant to be stabilized. For example, in the case of lime flavoring, silica gel can adsorb up to 68% flavorant by-weight, while for peach flavoring, silica gel can adsorb up to 73% flavorant by-weight. The lower end of adsorption is governed by the silica gel's pore size range. As previously discussed, smaller pore size ranges were found generally to provide lower flavorant loadings and lesser transfer of flavorant to packaged foodstuff.

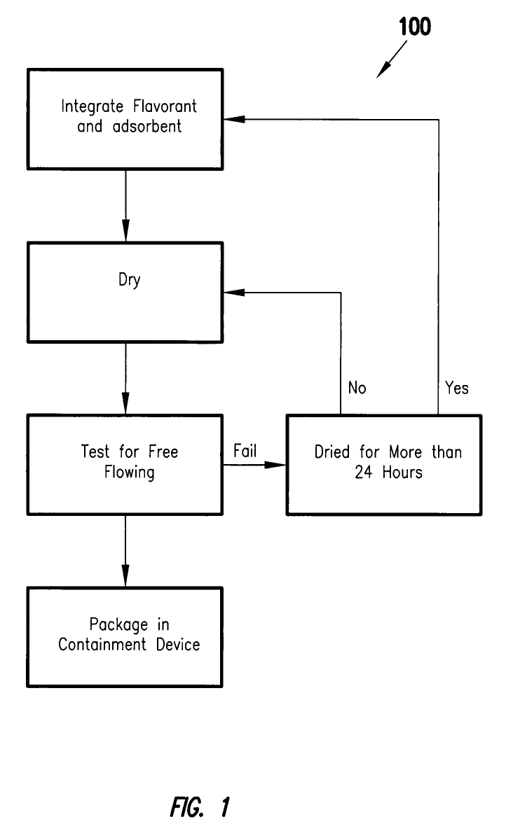

As shown in FIG. 1, flowchart 100 details an exemplary process, using the preferred stabilizer, in accordance with the following disclosure. A silica gel/flavorant composition is prepared by integrating the silica gel, i.e., an adsorbent/stabilizer, with the flavorant. Preferably, the flavorants are in a liquid medium (e.g., an oil, alcohol or water-based matrix) to allow for proper adsorption. The flavorants are added to the silica gel at the maximum loading factor, which is preferably at least about 50% by weight, or alternatively, at about a 1:1 ratio by-weight. The composition is then left to equilibrate for a time dependent upon the ratio and nature of flavorant used to achieve free flowing properties. Usually, this is for at least four hours. Preferably, the composition is left to equilibrate for twelve hours, but the best results are achieved after 24 hours of equilibration. It should be appreciated that up to 48 hours of equilibration may be necessary depending on batch size, stabilizer and/or flavorants. Preferably, the composition is free flowing after equilibration has been completed. The appearance of free flowing properties may be used as a “marker” signifying the equilibration step has been completed.

Once the composition is equilibrated, it can be deposited onto or into a delivery device. The delivery device can be one of a number of packaging devices which may also function as containments therefor. For example, a self-adhesive device, such as disclosed in U.S. Pat. No. 5,686,161 (Cullen et al.) may be employed, which device is incorporated by reference herein. Similar self-adhesive devices 14 are shown in FIGS. 2-8.

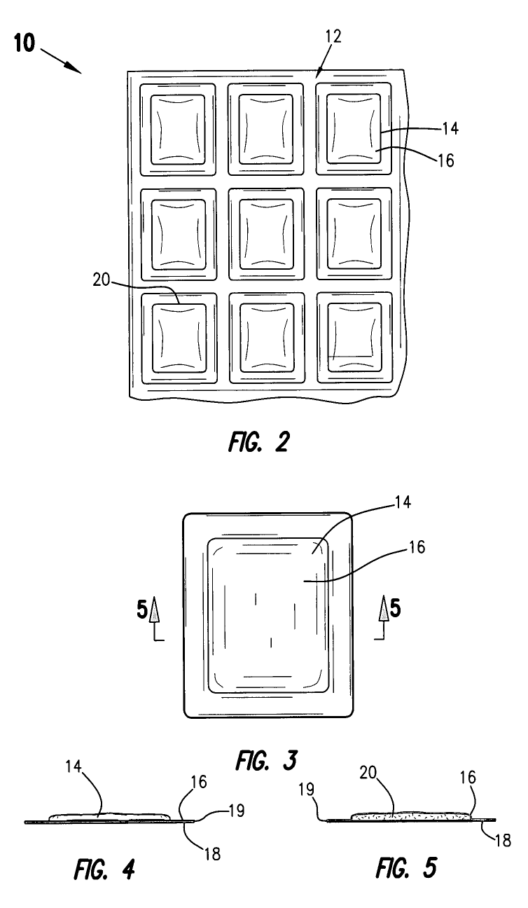

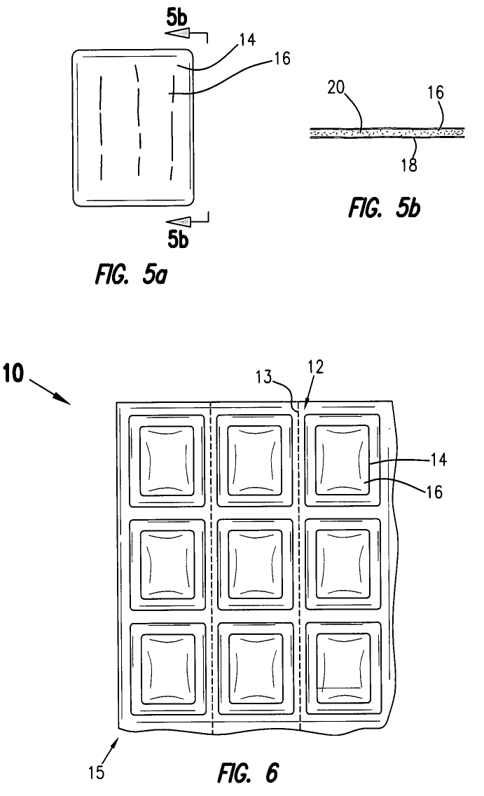

FIG. 2 illustrates a top view of self-adhesive device sheet 10, which is a sheet of a plurality of self-adhesive devices 14, and can alternatively be described as self-adhesive items containing a flavorant emitting composition (not shown in FIG. 2, but illustrated in FIG. 5), and are removably affixed to sheet 12. FIG. 3 shows a top view of self-adhesive device 14. FIG. 4 is a front view of self-adhesive device 14 comprising top sheet 16 and base sheet 18. FIG. 5 is a side-sectional view of self-adhesive device 14, illustrating flavorant emitting composition 20.

Optionally, flavorant emitting composition 20 may further comprise a humidity controlling device or moisturizer. Humidity controlling devices and moisturizers are known in the art, as disclosed by Cullen et al. supra. Cullen et al. disclose how silica gel, for example, can be used as a humidity control device. In some embodiments of the invention, flavorant emitting composition 20 can perform other functions, e.g., replacing volatilized flavorant with water vapor present in the airspace of the flavorant emitting device. Alternatively, some applications may require a moisture supplier, such as hydrogel as described in Cullen et al. In these applications, it may be desirable for the flavorant emitting compositions to further comprise a secondary adsorbent possessing different properties than the primary adsorbent. For example, a secondary silica gel adsorbent having smaller average pore sizes than the primary adsorbent may be desirable for better moisture adsorption.

Top sheet 16 is at least partially porous to allow for volatilization of the flavorant composition from the device. Top sheet 16 is preferably a spun-bonded olefin, such as Tyvek®, a trademark of E.I. DuPont which is commercially available through ordinary channels of commerce in rolls of various dimensions. It should be appreciated that virtually any porous material may be used, including those comprising polyolefin fibers, spunbonded fibers, microporous packaging materials, and various combinations thereof. Spunbonded fibers may include, but are not limited to: polyethylene, polypropylene, cottons, polylactic acid, pea protein fibers, cellulose, esters, resin fibers, olefins, polyesters, nylons, any other polymers capable of being formed into fibers, natural fibers capable of being formed into a sheet, woven or non-woven and combinations thereof, while microporous packaging materials may include, but are not limited to: esters, olefins, nylons, polymer films, metal sheets, metalized films, coated papers, uncoated papers, polymers, non-wovens, natural materials (cottons and felts), and combinations thereof. It may be appreciated that other polymers, including polylactic acid (PLA) and other biopolymers can be used. It should also be appreciated that perforation of microporous packaging materials may be performed by any known means, e.g., pins, lasers, corona discharge, electrostatic discharge. Additionally, it has been found that in a preferred embodiment, the porosity of top sheet 16 should range from about 0 seconds/square inch/cubic centimeter to about 5000 seconds/square inch/cubic centimeter, i.e., a measure of porosity known as Gurley Permeability.

Preferably, base sheet 18 comprises an adhesive backing. Base sheet 18 is readily strippable from holding sheet 12, as shown by FIG. 2. Porous top sheet 16 and base sheet 18 are sealed together around the perimeter of self-adhesive device 14, containing flavorant emitting composition 20. Preferably, peripheral seal 19 engaging porous top sheet 16 to base sheet 18 is by means of a heat seal, but can be sealed by any type of sealing means known in the art, such as embossing or bonding adhesive.

As previously disclosed, a preferred embodiment of the invention includes the judicious selection of stabilizers, which in some instances are granular and free flowing after allowing the flavor to be fully absorbed, i.e., stabilized. However, the invention also contemplates embodiments wherein stabilizers, instead of possessing free-flowing characteristics, possess natural adherent, adhesion, adhesive-like, tacky, gummy, gel or paste properties. In these embodiments, the flavorant emitting compositions may be affixed to a substrate, for example, prior to or during formation of a flavorant emitting device, and the flavorant emitting composition may or may not form a continuous layer. Resin stabilized flavors can be molded into a discrete form, or in an alternative, coated onto a surface. A coatable resin stabilized flavorant is a continuous coating layer wherein the coating layer may or may not also possess adhesive characteristics. Such a resin stabilized flavor composition may be applied to any substrate such as a packaging material using conventional coating, printing or imprinting techniques. Resins that are compatible would lend themselves to such a process, however, resins such as acrylics or hydroxypropylcellulose are preferred. Similarly, flavors can be stabilized by gums or gels, typically carbohydrates, however, proteins and some resins, such as polyacrylates, also lend themselves to be gel-like stabilizers. Additionally, some resins and gum stabilizers have adhesive characteristics, which allow them to form components of a one or two-sided laminated structure. A two sided laminate structure is shown in FIGS. 5a and 5b. In those instances, top sheet 20 is adhered to bottom sheet 18 via the adhesive characteristics of stabilized flavorant 16. Alternatively, top sheet 20 may be omitted, thereby creating a one sided laminated structure comprising stabilized flavorant 16 and bottom sheet 18. In both instances, the embodiments eliminate the sealed edges present in FIGS. 4 and 5. It is also important to note that because of the open sides, it is possible to have flavorant emitted from the open edges, as opposed to through either top sheet 16 and/or bottom sheet 18. This would be beneficial if top sheet 16 and/or bottom sheet 18 are not perforated, as is preferred in FIGS. 4 and 5.

As shown by FIG. 6, self-adhesive device sheet 10 can be scored with perforations 13 allowing for separation into strips 15 as shown in FIG. 7. Strip 15 can then be rolled up into roll 11 as shown in FIG. 8, for packaging and shipment of the self-adhesive devices.

An alternative to the self adhesive device described replaces the self adhesive base sheet with one that is more rigid, which lacks the self adhesive component. This structure could be simply inserted into the package as a drop in, or more preferably it can also double as a structural component for use in single or small serving applications, such as cookies, brownies, snack cakes, etc. Additionally, a further alternative to the self adhesive device is a similar device merely lacking the self adhesive design feature.

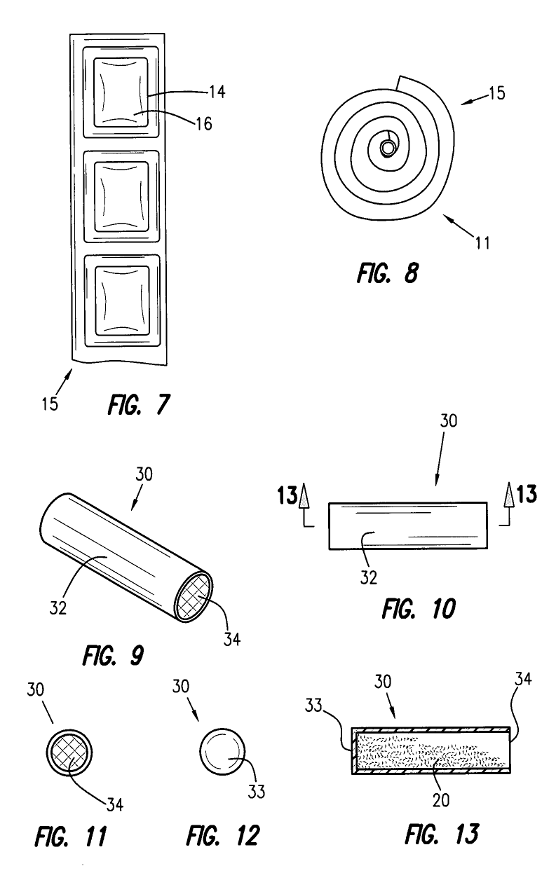

Flavorant emitting composition 20 can also be placed in canister type containment device 30, as shown by FIGS. 9-13. Canister 30 is exemplary of any closed containment device having outer surface 32, back surface 33 and front surface 34. In this embodiment, front surface 34 is at least partially porous, but it should be appreciated that any surface of canister 30 can be at least partially porous. FIG. 13 illustrates a sectional view of canister 30 comprising flavorant emitting composition 20. It should be appreciated that the stabilized flavor may be pressed, or otherwise formed into a shape, for insertion into a package, or enclosed space, from which flavor can be volatized. Additionally, the formed shape can be coated with a suitably transmissive material, or left uncoated as desired. In this regard, the invention also includes compressed and/or molded stabilized flavorant delivery systems, such as compressed or molded tablets, or uncoated or coated dosage forms, made by known methods commonly employed by the pharmaceutical industry. Compressed tablets, for example, eliminate the need for separate packaging means, e.g., top and bottom sheets 16 and 18, respectively, sachets, packets, etc., as discussed herein. In practicing these embodiments of the invention, suitable binders and excipients can be incorporated into the flavorant and stabilizer compositions, which in-turn can be compressed into composite structures, e.g., tablets, pills, boluses, and so on. Additionally, compressed shapes may be desirable when the given enclosure or food package has a unique shape, or space, wherein the tablet must fit into that shape snuggly. Representative binders would include those commonly employed in orally administered pharmaceutical tablets and similar-like dosage forms, e.g., sucrose syrups, gelatin, acacia mucilages, ethyl vinyl alcohol (EVOH) and polyvinyl pyrrolidone (PVP), and so on. It is also possible for the stabilizer to serve as the binder, e.g., EVOH, PVP, cellulose ethers, and acrylics. Additionally, a catalytically cured, or UV cured polymer may be used, such as acrylics or urethane polymers. Additionally, thermoplastic polymers are also acceptable binders, e.g., polyethylene, and ethylene vinyl acetate.

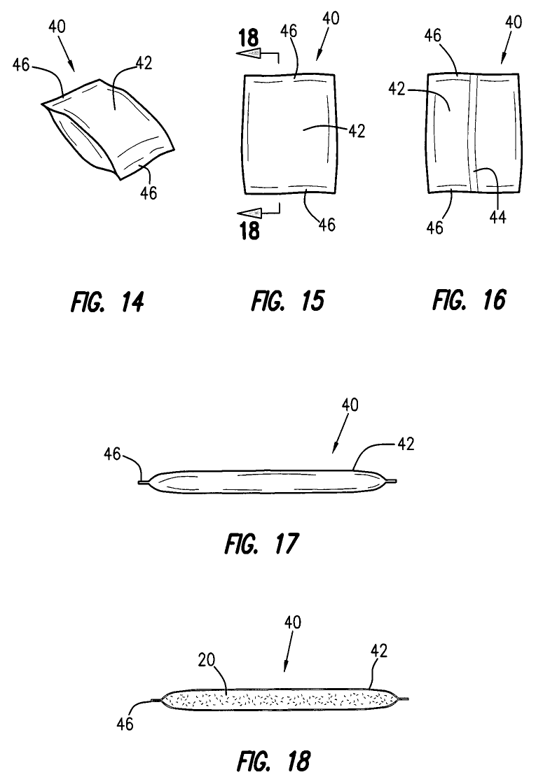

Alternatively, the flavorant compositions of the invention can also be wrapped or packaged in sachets using a suitable material that would allow volatilization of the composition, as shown by FIGS. 14-19. It should be appreciated that as used herein, i.e., within the specification and claims, sachet is intended to mean a small bag, case or pad containing a flavorant emitting composition therein. Sachet 40 comprises suitable material 42, closed with seals 46. Referring to FIG. 16, seal 44 is shown. Seals 44 and 46 are preferably heat seals. But, it will be appreciated that sealing can be performed by other means known in the art, such as adhesive sealing, (ultrasound) ultrasonic welding, and so on depending on the specific sachet material employed.

Sachet material 42 is preferably a spun-bonded olefin. It will be appreciated any porous material may be used including polyolefin fibers, spunbonded olefins, perforated polyester, perforated metallic sheet, and combinations thereof. Manufacturing with such a material can be easily accomplished by unrolling the material and cutting it into suitable pieces across the width of the material. The material can then be folded in half and sealed length-wise into a plurality of cavity pockets. Typically, these pockets have four sides, one of which does not require sealing because of the folded edge, and two opposing sides which are sealed. The remaining open side is available to allow the flavorant emitting composition to be introduced by injection. Once injected, this last side may then be sealed.

Alternatively, sachets 40 may be manufactured by unrolling the material and cutting it into suitable pieces across the width of the material. The material can then be folded and sealed across its length, creating a long tubular shell. One end of the tube of material can be sealed and the entire cavity filled with a flavorant emitting composition 20. The tube of material can then be sealed at predetermined locations, width-wise, creating a string of sachets 48. The sachets can then be scored with perforations 49 for easy separation and removal individually.

A further embodiment will be a string of sachets 48, as shown by FIG. 19, which can then be separated at perforations 49 to allow for convenient separation on a manufacturing line. Alternatively, the sachets can be cut apart from each other for individual distribution as shown by FIG. 14.

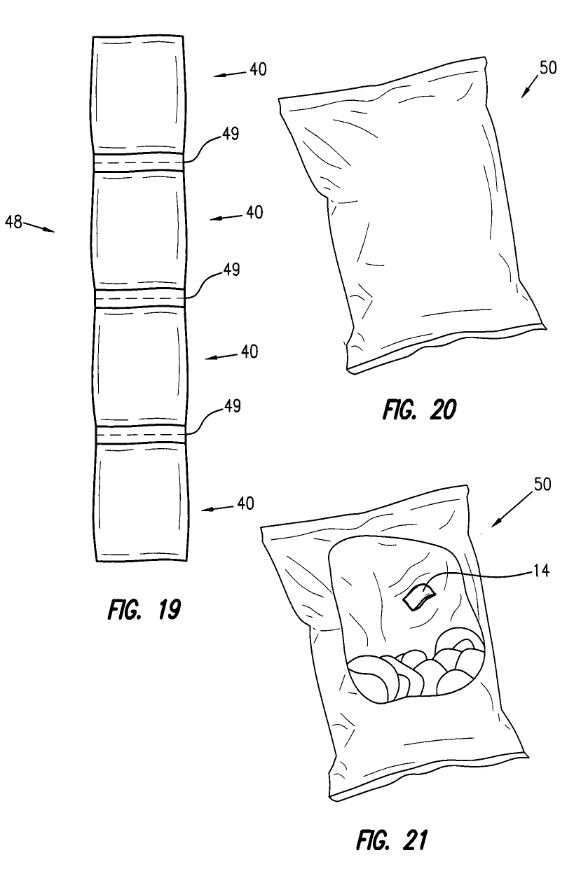

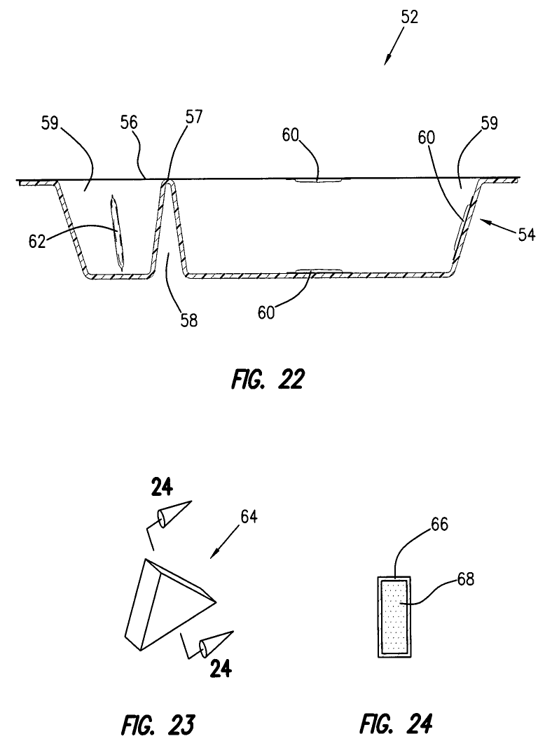

FIG. 20 illustrates an exterior view of a bag of edibles 50, containing flavorant self-adhesive device 14, most clearly shown by FIG. 21. It should be appreciated that bag 50 may contain any foodstuff, such as potato chips or any other snack food, for example, and is not restricted in any way to the specific items shown in the drawings. Furthermore, it should be appreciated that it is not necessary for self-adhesive device 14 to be used as a flavorant emitting device, but that any embodiment of the flavor emitting device according this invention, may be used. Flavorant self-adhesive device 14 is but one preferred embodiment of the packaged flavorant composition and method for imparting added flavor to packaged edibles 50 for maintaining and/or enhancing the aroma/flavor of packaged foodstuff for better consumer acceptance.

In yet another alternative embodiment of the invention, flavorant may be introduced into a thermoform tray 52, or other similar containment device, as illustrated by FIG. 22. Thermoforming is a process well known among skilled artisans, wherein heat and pressure (or vacuum) are employed to force a thermoplastic sheet against a mold face (not shown). Tray 52 comprises a solid thermoformed base portion 54, which can be partitioned with optional divider walls 58, thereby establishing compartments 59. A cover sheet 56 may be used to seal base portion 54 of the tray. In some embodiments, divider walls 58 may be heat sealed with cover sheet 56 at interfaces 57 thereby creating separate and distinct compartments 59. Having separate and distinct compartments 59 permits the introduction of a plurality of flavorant compositions within tray 52 without undesirable mixing of the flavorants, e.g., a blueberry flavorant in a compartment containing blueberry pie and a barbeque flavorant in a compartment containing spare ribs. Contrarily, in other embodiments, divider walls 58 are not heat sealed with cover sheet 56 and are present merely to maintain a separation between different foods. In those embodiments, flavorants may migrate between compartments. Any of the flavorant devices disclosed herein may be applied to or introduced into the tray interior surfaces and/or tray cover, e.g., adhesive patches 60, sachets 62 or loose insert. Additionally, molded tablets or shapes, as described supra, may be designed to conform to and fit within an available space within tray 52, e.g., within the base of compartments 59. As described above, a present invention stabilized flavorant may be coated on a substrate. Thus, a further embodiment of the present invention includes coating cover sheet 56 so that food products contained therebelow are exposed to such stabilized flavorants. As with the previous embodiments described above, cover sheet 56 may be coated with a single stabilized flavorant or a plurality of flavorants, each corresponding to a particular compartment of tray 52. Heating of food products contained within tray 52 may be accomplished by any conventional method, such as microwave, boiling, or baking in either a traditional or convection oven, and such heating may enhance volatilization of the flavorant and further facilitate flavor transfer.

FIG. 23 shows a perspective view of a tablet type containment/release packaging for the flavor emitting compositions of the invention, while FIG. 24 shows a side sectional view of the tablet type containment/release packaging taken along line 24-24 of FIG. 23. Tablet 64 is shown having a generally pyramidal shape, however it should be appreciated that any moldable shape is possible for tablet 64, e.g., cylindrical, spherical, etc., and such variations are within the spirit and scope of the claimed invention. In the embodiment shown in FIGS. 23 and 24, tablet 64 is enclosed by coating 66 as described supra. Thus, flavorant emitting composition 68 is enclosed within coating 66, thereby preventing dusting and/or controlling volatility of flavorant emitting composition 68, for example. Coating 66 may also provide increased compatibility between tablet 64 and the product with which tablet 64 is packaged. It should be appreciated that tablet 64 may be either coated or uncoated, and such variations are also within the scope of the claimed invention. Additionally, flavorant emitting composition 68 may or may not include a separate binder material to assist with maintaining the structural integrity of tablet 64 because the flavorant and/or stabilizer components may act as a binder.

It should also be appreciated that some of the embodiments described supra are especially useful as a flavorant source for masking the taste of pediatric medications, such as vitamins, antibiotics, etc., by making them more palatable, and therefore, more readily acceptable to the patient. For example, a flavorant emitting sachet or self-adhesive packet may be included within a pill bottle, thereby imparting desirable flavors to vitamins or medication stored therein.

The following best mode working Examples of the invention will provide further enablement for practicing the invention.

### EXAMPLE 1

A lime flavorant emitting composition was prepared according to the following protocol. 10 grams of silica gel having a porous surface with an average pore size of about 300 Å was placed in a screw top glass jar, to which was added 10 grams of lime essence from International Flavors and Fragrances, Inc. (IFF), New York, N.Y., in a 1:1 ratio by-weight, which sat for 48 hours. The silica gel is known as “B” type and is available from Kaltron, Bensenville, Ill. or Transo-Pharm, Blue Bell, Pa. The silica gel was particulate, having a diameter range of 0.1-0.5 mm. The jar was capped tightly and hand shook for about five minutes, until it appeared that the flavorant was equally dispersed with the silica gel. The jar was opened and a spatula used to further increase the dispersing of the flavorant. Once it appeared the flavorant was dispersed evenly, and that the silica gel appeared to be moist the composition was allowed to set for 48 hours to permit the silica gel to absorb the flavorant, thus stabilizing it. This yielded a flavorant emitting composition of 0.61 grams/cc. A further iteration of this example was conducted, resulting in finding a maximum loading of lime flavorant to be 68% by weight while still maintaining free flowing characteristics.

### EXAMPLE 2

The composition in Example 1 was scaled up as follows: 1250 g of silica gel having a porous surface with an average pore size of about 300 Å, was added to the bowl of a standard Kitchen Aid® brand countertop mixer. After which, 1250 g of lime flavorant from IFF was added to the bowl. The head of the mixer was lowered into the bowl and the mixer was actuated at a speed such that no dust was dispersed from the silica gel. After approximately five minutes, the mixer was disengaged, and the gel was inspected for flavor dispersion. Once the flavorant appeared to be well blended and the silica gel appeared to be moist, the mixture was transferred to an appropriate container and allowed to equilibrate for 48 hours. This allowed the gel and flavorant to equilibrate and the gel to absorb the lime flavorant. This yielded a composition similar to Example 1.

### EXAMPLE 3

A tutti frutti flavorant emitting composition was prepared according to the following protocol: 10 grams of silica gel having a porous surface with an average pore size of about 300 Å was placed in a screw top glass jar, to which was added 10 grams of tutti frutti essence from International Flavors and Fragrances, Inc. The silica gel was “B” type and available from Kaltron or Transo-Pharm. The silica gel was particulate having a diameter range of 0.1 to 0.5 mm. The jar was capped and hand shook for about 5 minutes, until it appeared the flavorant was uniformly dispersed with the silica gel. The top of the jar was removed and a spatula used to further increase the dispersion of flavorant. Once it appeared that the flavorant was dispersed evenly, and that the silica gel appeared moist, the composition was allowed to set for 48 hours to allow the silica gel to absorb the flavorant, thus stabilizing it. This yielded a flavorant emitting composition of 0.60 gram/cc.

### EXAMPLE 4

The composition in Example 3 was scaled up as follows: 1250 g of silica gel having a porous surface with an average pore size of about 300 Å, was added to the bowl of a standard Kitchen Aid brand countertop mixer. After which, 1250 g of tutti frutti flavorant from IFF was added to the bowl. The head of the mixer was lowered into the bowl and the mixer was initiated at a speed such that no dust was dispersed from the silica gel. After approximately five minutes, the mixer was disengaged, and the gel inspected for flavorant dispersion. Once the flavorant looked well blended and the gel appeared moist, the mixture was transferred to an appropriate receptacle and allowed to equilibrate for 48 hours, thus allowing the gel and flavorant to equilibrate and the gel to absorb the flavorant. This yielded a composition similar to that of example 3.

### EXAMPLE 5

A cilantro flavorant emitting composition was prepared as follows. 10 grams of silica gel having a porous surface with an average pore size of about 300 Å was placed in a screw top glass jar, to which was added 10 grams of cilantro essence from International Flavors and Fragrances, Inc. The silica gel was “B” type from Kaltron or Transo-Pharm. The silica gel was particulate with a diameter range of 0.1-0.5 mm. The jar was then tightly capped and hand shook for about five minutes, until it appeared that the flavorant was evenly dispersed with the silica gel. The glass jar top was then removed and a spatula was used to further increase the dispersion of flavorant. Once it appeared that the flavorant was dispersed evenly, and that the silica gel appeared moist, the composition was allowed to set for 48 hours to allow the silica gel to absorb the flavorant, thus stabilizing it. This yielded a flavorant emitting composition of 0.60 grams/cc. The method of this example was repeated, resulting in a maximum loading of cilantro flavorant to be 51% by-weight while still maintaining free flowing properties.

### EXAMPLE 6

A flavorant emitting patch was made using 0.3 grams of the cilantro flavorant emitting composition from Example 3. The composition was deposited onto a laminate base sheet structure consisting of a structural layer, an adhesive layer, and a release liner. This web with deposit was then covered with a perforated top sheet which was heat sealed to the base sheet structure. That composite web was then die cut into small patches, in such a manner as to cut through the top and bottom sheet, but without cutting the release liner. The excess material was then removed from the web, leaving a web of discrete adhesive patches. The liner was then finally split so that the patches were in continuous strips, so they were suitable for automatic dispensing. Several patches were then tested. Over time it was apparent that the sorbent patch did allow the volatilized flavorant to pass through the top sheet and into the environment.

### EXAMPLE 7

Several flavorant emitting patches were prepared using 0.3 grams of flavorant emitting compositions comprising lemon, peppermint, and tea flavorants. Three sets of 10 grams each of silica gel having porous surfaces with average pore sizes of about 300 Å were placed into separate screw top glass jars, to which was added 10 grams of either lemon, peppermint and tea essence from International Flavors and Fragrances, Inc. The silica gel was type “B”. The silica gel was in a particulate format having a diameter ranging from 0.1-0.5 mm. The jars were then capped tightly and hand shook for about five minutes, until it appeared the flavorant was equally dispersed with the silica gel. The tops were then removed from each jar and a spatula used to further increase the dispersion of flavorant. The spatula was cleaned between uses to prevent cross contamination. Once it appeared that the flavorants were dispersed evenly, and that the silica gels appeared moist, the compositions were allowed to set for 48 hours for the silica gel to absorb the flavorant, thus stabilizing it. The compositions were deposited onto discrete pieces of a base sheet similar to that described in Example 6. These were then covered with discrete pieces of a coated Tyvek® top sheet with the coated side heat sealed to the base sheet using a standard bench top impulse heat sealer. Any excess material was trimmed. The sorbent patches were all 1.75 inch×1.5 inch rectangular shapes, with 1/16″ seals.

Similar sorbent patches were also prepared using 0.250 grams of flavorant emitting composition comprising fajita, pepperoni, baked pizza, and cheese pizza flavorants from International Flavors and Fragrances, Inc. Again, each of these compositions and adhesive patches were prepared using the same methods as disclosed above.

### EXAMPLE 8

A strawberry emitting flavor composition was created as follows. A non-ionic cellulose ether, more specifically hydroxypropylcellulose obtained from International Fiber of North Tonawanda, N.Y., was added to a beaker and dispersed in water at a percentage of about 12% resin (w/w). Subsequently 15%, by weight, of strawberry flavorant from International Flavors and Fragrances was added to the beaker. The contents were stirred vigorously with a stir stick until well combined. The resulting mixture was allowed to set for 24 hours. Upon inspection, there was no phase separation, and the resin mixture emitted strawberry flavorant into the ambient environment. The resultant flavor/resin composition was imprinted on to a base film from which the strawberry flavor was emitted.

### EXAMPLE 9

Flavorant is prepared in silica gel as shown above to produce 5 lbs of stabilized flavorant. After the composition is equilibrated, it is placed in a Sigma-type blender and allowed to mix on its own for around 10 minutes. After this, around 1.6 lbs, or 25% by weight, of PVP is added to the blender, and the two components are allowed to mix for around 2 hours. The resulting mixture is then taken to a bench top press where the formulation is spooned into the cavity, and compressed at 10 lbs of pressure for around one second (duration and pressure varies depending on press used), resulting in a compressed form. This form emitted flavorant factors over time. An additional step may be performed wherein the compressed form is coated with a food grade coating, via a standard pan coater employing standard coating techniques.

### EXAMPLE 10

Flavorant is prepared in silica gel as shown above to produce 5 lbs of stabilized flavorant. After the composition is equilibrated, it is placed in a Sigma-type blender and allowed to mix on its own for around 10 minutes. After this, about 5 lbs, or 10% by weight of EVA is added to the blender, and the two components are allowed to mix for 10 minutes. The resulting mixture is then taken to a bench top press, where the formulation is spooned into the cavity and compressed at 10 lbs of pressure for around one second (duration and pressure varies depending on press used), resulting in a compressed form. This form emitted flavorant factors over time. An additional step can be performed wherein the compressed form is coated in a food grade coating, via a standard pan coater, with standard coating techniques.

### EXAMPLE 11

75 g of distilled water was added to a beaker, followed by 0.06 g of ProClin 300 Preservative from Sigma Aldrich Corporation, St. Louis, Mo. These were mixed together by hand for 30 seconds. After mixing, 9 g of carrageenan from Ingredient Solutions, Inc., Waldo, Me., was added, and the solution was mixed for another 30 seconds by hand. Finally, 9 g of lime flavorant from International Flavors and Fragrances was added, and mixed together for 60 seconds. The resultant composition had a translucent yellow color, and presented itself in light, fluffy chunks with rubber-like consistency. Further experimentation showed that a simple increase in either the water or flavorant would thin out the mixture into a paste.

### EXAMPLE 12

A series of tests were conducted to demonstrate the flavorant release characteristics of products made according to the present invention.

Test samples were prepared using flavorants available under the names Blueberry Cream; Lemonade; Baked Bread; Honey Clover and Honey. Test specimen samples were prepared wherein each contained 0.25 grams of the foregoing flavorants impregnated onto 0.25 grams of Transo-Pharma silica gel having an average pore size of 300 angstroms. Test samples of silica gel were impregnated with the flavorant by mixing the flavorant with the silica gel in a 1:1 ratio, and allowing each flavorant sample to sit for a 24 hour period in order to equilibrate.

The flavorant-adsorbent test specimens were each packaged in sorbent patches measuring 1.75 inches×1.5 inches, wherein the base sheet of the patches was a polyester film with a polyethylene extrusion coating on the polyester. The top sheet of each patch consisted of DuPont's Tyvek® spunbonded non-woven film, which allows the transmission of flavorant from the specimens to pass therethrough. The patches were sealed with a heat seal coating layer.

Test patches were placed in a Isotemp Vacuum Oven Model 282A and the vacuum turned on and held at 0.1 to 0.5 inches of Hg at 23° C. The samples were weighed using a Mettler Toledo AG245 4 place analytical balance before going into the oven and after every so many days until their weights became constant.

The test data and conclusions are provided below:

TABLE I
LEMONADE

| | | | | | | | Average % |
|---|---|---|---|---|---|---|---|
| | | % Flavor | | % Flavor | | % Flavor | Flavor |
| Hours | Lemonade 1 | Emitted | Lemonade 2 | Emitted | Lemonade 3 | Emitted | Emitted |
| 0 | 0.7559 | | 0.7259 | | 0.7607 | | 0.00 |
| 4 | 0.7214 | 27.6 | 0.6884 | 30 | 0.723 | 30.16 | 29.3 |
| 8 | 0.7165 | 31.52 | 0.6832 | 34.16 | 0.7156 | 36.08 | 33.9 |
| 24 | 0.7093 | 37.28 | 0.677 | 39.12 | 0.7081 | 42.08 | 39.5 |
| 28 | 0.7077 | 38.56 | 0.6756 | 40.24 | 0.7064 | 43.44 | 40.7 |
| 32 | 0.7063 | 39.68 | 0.6745 | 41.12 | 0.7047 | 44.8 | 41.9 |
| 48 | 0.7025 | 42.72 | 0.6714 | 43.6 | 0.7014 | 47.44 | 44.6 |
| 53 | 0.7014 | 43.6 | 0.6706 | 44.24 | 0.7008 | 47.92 | 45.3 |
| 58 | 0.7011 | 43.84 | 0.6703 | 44.48 | 0.7006 | 48.08 | 45.5 |
| 72 | 0.6983 | 46.08 | 0.669 | 45.52 | 0.6986 | 49.68 | 47.1 |
| 135 | 0.6917 | 51.36 | 0.6619 | 51.2 | 0.6943 | 53.12 | 51.9 |
| 159 | 0.6893 | 53.28 | 0.6599 | 52.8 | 0.6923 | 54.72 | 53.6 |
| 255 | 0.6825 | 58.72 | 0.653 | 58.32 | 0.6867 | 59.2 | 58.7 |
| 471 | 0.6802 | 60.56 | 0.6514 | 59.6 | 0.685 | 60.56 | 60.2 |
| 591 | 0.6756 | 64.24 | 0.6475 | 62.72 | 0.6804 | 64.24 | 63.7 |

TABLE II
BAKED BREAD

| | | | | | | | Average % |
|---|---|---|---|---|---|---|---|
| | Baked | % Flavor | Baked | % Flavor | Baked | % Flavor | Flavor |
| Hours | Bread 1 | Emitted | Bread 2 | Emitted | Bread 3 | Emitted | Emitted |
| 0 | 0.7402 | | 0.75 | | 0.7468 | | 0 |
| 4 | 0.6633 | 61.52 | 0.6666 | 69.36 | 0.6638 | 66.4 | 65.8 |
| 8 | 0.6625 | 62.16 | 0.6658 | 70 | 0.6631 | 66.96 | 66.4 |
| 24 | 0.664 | 60.96 | 0.6671 | 68.8 | 0.6652 | 65.28 | 65.0 |
| 28 | 0.664 | 60.96 | 0.6667 | 68.8 | 0.665 | 65.44 | 65.1 |
| 32 | 0.6642 | 60.8 | 0.6672 | 68.64 | 0.6652 | 65.28 | 64.9 |
| 48 | 0.6651 | 60.08 | 0.6682 | 67.92 | 0.666 | 64.64 | 64.2 |
| 53 | 0.6651 | 60.08 | 0.6682 | 67.92 | 0.6659 | 64.72 | 64.2 |
| 58 | 0.6653 | 59.92 | 0.6687 | 67.76 | 0.6662 | 64.48 | 64.1 |
| 72 | 0.6657 | 59.6 | 0.6688 | 67.44 | 0.6662 | 64.48 | 63.8 |
| 135 | 0.6669 | 58.64 | 0.67 | 66.48 | 0.6662 | 64.48 | 63.2 |
| 159 | 0.6669 | 58.64 | 0.67 | 66.48 | 0.668 | 63.04 | 62.7 |
| 255 | 0.6667 | 58.8 | 0.67 | 66.64 | 0.6679 | 63.12 | 62.9 |
| 471 | 0.6693 | 56.72 | 0.6725 | 64.56 | 0.6707 | 60.88 | 60.7 |

TABLE III
HONEY CLOVER

| | | | | | | | Average % |
|---|---|---|---|---|---|---|---|
| | Honey | % Flavor | Honey | % Flavor | Honey | % Flavor | Flavor |
| Hours | Clover 1 | Emitted | Clover 2 | Emitted | Clover 3 | Emitted | Emitted |
| 0 | 0.7822 | | 0.7803 | | 0.7507 | | |
| 4 | 0.7559 | 21.04 | 0.7533 | 21.6 | 0.7238 | 21.52 | 21.4 |
| 8 | 0.7533 | 23.12 | 0.7508 | 23.6 | 0.7214 | 23.44 | 23.4 |
| 24 | 0.7504 | 25.44 | 0.7475 | 26.24 | 0.7183 | 25.92 | 25.9 |
| 28 | 0.7494 | 26.24 | 0.7465 | 27.04 | 0.717 | 26.96 | 26.7 |
| 32 | 0.7485 | 26.96 | 0.7456 | 27.76 | 0.7161 | 27.68 | 27.5 |
| 48 | 0.7462 | 28.8 | 0.743 | 29.84 | 0.7133 | 29.92 | 29.5 |
| 53 | 0.7455 | 29.36 | 0.742 | 30.64 | 0.7124 | 30.64 | 30.2 |
| 58 | 0.7544 | 22.24 | 0.7419 | 30.72 | 0.7124 | 30.64 | 27.9 |
| 72 | 0.7434 | 31.04 | 0.7398 | 32.4 | 0.7099 | 32.64 | 32.0 |
| 135 | 0.7392 | 34.4 | 0.7344 | 36.72 | 0.7043 | 37.12 | 36.1 |
| 159 | 0.7371 | 36.08 | 0.7323 | 38.4 | 0.702 | 38.96 | 37.8 |
| 255 | 0.7313 | 40.72 | 0.7262 | 43.28 | 0.6955 | 44.16 | 42.7 |
| 471 | 0.7297 | 42 | 0.7235 | 45.44 | 0.6923 | 46.72 | 44.7 |
| 591 | 0.7245 | 46.16 | 0.7174 | 50.32 | 0.6859 | 51.84 | 49.4 |

TABLE IV
HONEY

| | | | | | | | Average % |
|---|---|---|---|---|---|---|---|
| | | % Flavor | | % Flavor | | % Flavor | Flavor |
| Hours | Honey 1 | Emitted | Honey 2 | Emitted | Honey 3 | Emitted | Emitted |
| 0 | 0.7746 | | 0.8103 | | 0.7909 | | |
| 4 | 0.7697 | 3.92 | 0.8052 | 4.08 | 0.7859 | 4 | 4.0 |
| 8 | 0.7681 | 5.2 | 0.8032 | 5.68 | 0.7839 | 5.6 | 5.5 |
| 24 | 0.7673 | 5.84 | 0.8023 | 6.4 | 0.7829 | 6.4 | 6.2 |
| 28 | 0.7668 | 6.24 | 0.802 | 6.64 | 0.7823 | 6.88 | 6.6 |
| 32 | 0.7666 | 6.4 | 0.8012 | 7.28 | 0.7821 | 7.04 | 6.9 |
| 48 | 0.7657 | 7.12 | 0.8008 | 7.6 | 0.7811 | 7.84 | 7.5 |
| 53 | 0.7655 | 7.28 | 0.8004 | 7.92 | 0.7807 | 8.16 | 7.8 |
| 58 | 0.7657 | 7.12 | 0.8006 | 7.76 | 0.7808 | 8.08 | 7.7 |
| 72 | 0.7644 | 8.16 | 0.7996 | 8.56 | 0.78 | 8.72 | 8.5 |
| 135 | 0.7649 | 7.76 | 0.7997 | 8.48 | 0.7798 | 8.88 | 8.4 |
| 159 | 0.7646 | 8 | 0.7993 | 8.8 | 0.7793 | 9.28 | 8.7 |
| 255 | 0.7631 | 9.2 | 0.7976 | 10.16 | 0.7777 | 10.56 | 10.0 |
| 471 | 0.7652 | 7.52 | 0.7997 | 8.48 | 0.7799 | 8.8 | 8.3 |

TABLE V
BLUEBERRY

| | | | | | | | Average % |
|---|---|---|---|---|---|---|---|
| | Blueberry | % Flavor | Blueberry | % Flavor | Blueberry | % Flavor | Flavor |
| Hours | Cream 1 | Emitted | Cream 2 | Emitted | Cream 3 | Emitted | Emitted |
| 0 | 0.7786 | | 0.7716 | | 0.7712 | | |
| 4 | 0.7543 | 19.44 | 0.7462 | 20.32 | 0.7494 | 17.44 | 19.1 |
| 8 | 0.7459 | 26.16 | 0.7373 | 27.44 | 0.7424 | 23.04 | 25.5 |
| 24 | 0.7313 | 37.84 | 0.7221 | 39.6 | 0.7295 | 33.36 | 36.9 |
| 28 | 0.7282 | 40.32 | 0.719 | 42.08 | 0.7267 | 35.6 | 39.3 |
| 32 | 0.7254 | 42.56 | 0.7164 | 44.16 | 0.7241 | 37.68 | 41.5 |
| 48 | 0.7194 | 47.36 | 0.7106 | 48.8 | 0.7179 | 42.64 | 46.3 |
| 53 | 0.7177 | 48.72 | 0.7097 | 49.52 | 0.7161 | 44.08 | 47.4 |
| 58 | 0.7167 | 49.52 | 0.7086 | 50.4 | 0.7154 | 44.64 | 48.2 |
| 72 | 0.7137 | 51.92 | 0.7057 | 52.72 | 0.712 | 47.36 | 50.7 |
| 135 | 0.7065 | 57.68 | 0.6985 | 58.48 | 0.7052 | 52.8 | 56.3 |
| 159 | 0.7039 | 59.76 | 0.6963 | 60.24 | 0.7029 | 54.64 | 58.2 |
| 255 | 0.6972 | 65.12 | 0.6889 | 66.16 | 0.697 | 59.36 | 63.5 |
| 471 | 0.6949 | 66.96 | 0.6863 | 68.24 | 0.6948 | 61.12 | 65.4 |
| 591 | 0.689 | 71.68 | 0.6805 | 72.88 | 0.6894 | 65.44 | 70.0 |

While the rate of release of flavorant varied according to the particular chemical composition of flavorant tested, the test results generally demonstrated favorable controlled release characteristics, i.e., continued to release flavorant for periods ranging from hours to weeks. For example, baked bread flavor was one of the fastest to volatilize from the test patch, wherein 66.4% of the flavorant was released in the first 8 hours, and no further flavorant was delivered thereafter. However, honey flavor demonstrated a slower rate of volatilization and release from the patch device, wherein only 10% of the flavorant was delivered after more than 10 days (255 hours), and no further flavorant was released thereafter. Other noteworthy results include continued, sustained release of blueberry cream flavorant, wherein 70% of the flavorant was released over a sustained period of more than 24 days (591 hours). Other similar results were shown in the case of honey clover flavorant wherein about 50% of the flavorant was delivered over more than 24 days. On average, with all of the flavors most of the flavor was delivered in the first 2 to 3 days into the test runs.

What is claimed is:

1. A flavorant emitting composition comprising at least one flavorant in combination with a stabilizer, wherein said at least one flavorant is stabilized during processing and emitted from said composition when in an enclosed environment.

2. The flavorant emitting composition of claim 1, wherein said composition is characterized by at least one property selected from the group consisting of: granular, free flowing, moldable, imprintable, coatable, adhesion, and combinations thereof.

3. The flavorant emitting composition of claim 1, wherein the stabilizer is an adsorbent, an absorbent or combinations thereof.

4. The flavorant emitting composition of claim 1, wherein said stabilizer is a member selected from a group consisting of: hydrocolloids, gel, resins, polyvinyl pyrrolidone, polyvinyl alcohol, methyl acrylates, ethyl acrylates, butyl acrylates, methacrylates, ethyl cellulose, methyl cellulose, sodium carboxymethyl cellulose, alginate gums, sorbents, silica gels, silica hydrogels, activated carbons, diatomaceous earth, pearlite, zeolytes, molecular sieves, clays, microporous polymers, expanded polystyrene beads, gums, pastes, cellulose fibers, acrylic resins, cellulose ethers, thermoplastic resins, thermosetting resins and mixtures thereof.

5. The flavorant emitting composition of claim 3, wherein said stabilizer is a silica gel.

6. The flavorant emitting composition of claim 5, wherein the silica gel comprises a pore size range from about 285 Å to about 315 Å.

7. The flavorant emitting composition of claim 5, wherein the silica gel comprises an average pore size of about 300 Å.

8. The flavorant emitting composition of claim 5, wherein said silica gel is granular and comprises particle sizes ranging from about 0.01 mm to about 2.0 mm.

9. A flavorant emitting device comprising the composition of claim 1.

10. A flavorant emitting device comprising the composition of claim 2.

11. A flavorant emitting device comprising the composition of claim 3.

12. A flavorant emitting device comprising the composition of claim 4.

13. A flavorant emitting device comprising the composition of claim 5.

14. A flavorant emitting device comprising the composition of claim 6.

15. A flavorant emitting device comprising the composition of claim 7.

16. A flavorant emitting device comprising the composition of claim 8.

17. The flavorant emitting device of claim 9, which is a member selected from the group consisting of: a self-adhesive device, a canister, a tray, a tablet, a sheet, a coating and a sachet.

18. The flavorant emitting device of claim 10, which is a member selected from the group consisting of: a self-adhesive device, a canister, a tray, a tablet, a sheet, a coating and a sachet.

19. The flavorant emitting device of claim 11, which is a member selected from the group consisting of: a self-adhesive device, a canister, a tray, a tablet, a sheet, a coating and a sachet.

20. The flavorant emitting device of claim 12, which is a member selected from the group consisting of: a self-adhesive device, a canister, a tray, a tablet, a sheet, a coating and a sachet.

21. The flavorant emitting device of claim 13, which is a member selected from the group consisting of: a self-adhesive device, a canister, a tray, a tablet, a sheet, a coating and a sachet.

22. The flavorant emitting device of claim 14, which is a member selected from the group consisting of: a self-adhesive device, a canister, a tray, a tablet, a sheet, a coating and a sachet.

23. The flavorant emitting device of claim 15, which is a member selected from the group consisting of: a self-adhesive device, a canister, a tray, a tablet, a sheet, a coating and a sachet.

24. The flavorant emitting device of claim 16, which is a member selected from the group consisting of: a self-adhesive device, a canister, a tray, a tablet, a sheet, a coating and a sachet.

25. The flavorant emitting device of claim 9, wherein said device is a self-adhesive device comprising an adhesive base sheet and a porous top sheet, wherein edges of the device are sealed.

26. The flavorant emitting device of claim 25, wherein said porous top sheet comprises a member selected from the group consisting of: polyolefin fibers, spunbonded fibers, microporous packaging materials, and combinations thereof.

27. The flavorant emitting device of claim 26, wherein said spunbonded fibers comprises a fiber selected from the group consisting of: polyethylene, polypropylene, cottons, polylactic acid, pea protein fibers, cellulose, esters, resin fibers, olefins, polyesters, nylons, any other polymers capable of being formed into fibers, natural fibers capable of being formed into a sheet, woven or non-woven and combinations thereof.

28. The flavorant emitting device of claim 26, wherein said microporous packaging materials comprises a material selected from the group consisting of: esters, olefins, nylons, polymer films, metal sheets, metalized films, coated papers, uncoated papers, polymers, non-wovens, natural materials, and combinations thereof.

29. The flavorant emitting device of claim 9, wherein said device is a self-adhesive device comprising an adhesive base sheet and a porous top sheet, wherein edges of the device are unsealed.

30. The flavorant emitting device of claim 9, wherein said device is inserted within a molded tray.

31. A compressed or molded tablet comprising the flavorant composition according to claim 1.

32. A compressed or molded tablet comprising the flavorant composition according to claim 2.

33. A compressed or molded tablet comprising the flavorant composition according to claim 3.

34. A compressed or molded tablet comprising the flavorant composition according to claim 4.

35. A compressed or molded tablet comprising the flavorant composition according to claim 5.

36. A packaged food product comprising the flavorant device of claim 9, wherein said at least one flavorant is absorbed by said packaged food product.

37. A packaged food product comprising the flavorant device of claim 10, wherein said at least one flavorant is absorbed by said packaged food product.

38. A packaged food product comprising the flavorant device of claim 11, wherein said at least one flavorant is absorbed by said packaged food product.

39. A packaged food product comprising the flavorant device of claim 12, wherein said at least one flavorant is absorbed by said packaged food product.

40. A packaged food product comprising the flavorant device of claim 13, wherein said at least one flavorant is absorbed by said packaged food product.

41. A packaged food product comprising the flavorant device of claim 14, wherein said at least one flavorant is absorbed by said packaged food product.

42. A packaged food product comprising the flavorant device of claim 15, wherein said at least one flavorant is absorbed by said packaged food product.

43. A packaged food product comprising the flavorant device of claim 16, wherein said at least one flavorant is absorbed by said packaged food product.

44. A packaged food product comprising the flavorant device of claim 17, wherein said at least one flavorant is absorbed by said packaged food product.

45. A packaged food product comprising the flavorant device of claim 18, wherein said at least one flavorant is absorbed by said packaged food product.

46. A packaged food product comprising the flavorant device of claim 19, wherein said at least one flavorant is absorbed by said packaged food product.

47. A packaged food product comprising the flavorant device of claim 20, wherein said at least one flavorant is absorbed by said packaged food product.

48. A packaged food product comprising the flavorant device of claim 21, wherein said at least one flavorant is absorbed by said packaged food product.

49. A packaged food product comprising the flavorant device of claim 22, wherein said at least one flavorant is absorbed by said packaged food product.

50. A packaged food product comprising the flavorant device of claim 23, wherein said at least one flavorant is absorbed by said packaged food product.

51. A packaged food product comprising the flavorant device of claim 24, wherein said at least one flavorant is absorbed by said packaged food product.

52. A method of manufacturing a flavorant emitting device comprising the steps of:
(i) integrating a stabilizer with at least one flavorant to create a flavorant emitting composition; and,
(ii) packaging said flavorant emitting composition in an at least partially porous containment device.

53. The method according to claim 52, wherein the step of packaging said flavorant emitting composition in an at least partially porous containment device further comprises:
depositing said flavorant emitting composition onto a base sheet to form a base layer;
covering said base layer with a top sheet; and,
sealing said top sheet to said base layer.

54. A method of manufacturing a flavorant emitting composition comprising the steps of:
selecting at least one flavorant absorbable in a packaged food product;
selecting a stabilizer that will combine with said flavorant to form a solid or semi-solid form; and,
combining said selected at least one flavorant with said selected stabilizer to obtain said flavorant emitting composition.
